(19) United States
(12) Patent Application Publication
(10) Pub. No.: US 2024/0166362 A1
(43) Pub. Date: May 23, 2024

(54) AIRCRAFT REMOVABLE EQUIPMENT FITTING DEVICE

(71) Applicant: Airbus Operations S.L.U., GETAFE (ES)

(72) Inventor: Ignacio Santiago ENEBRAL TRIGO, GETAFE (ES)

(21) Appl. No.: 18/514,045

(22) Filed: Nov. 20, 2023

(30) Foreign Application Priority Data
Nov. 22, 2022 (EP) 22383120.7

(51) Int. Cl. B64D 41/00; F16B 2/06

(52) U.S. Cl. CPC B64D 41/00; F16B 2/065; B64D 2041/002

(57) ABSTRACT

An aircraft removable equipment fitting device, the aircraft comprising a structure to which the removable equipment is configured to be attached. The aircraft removable equipment fitting device includes a first coupling configured to be joined to the aircraft structure, a second coupling configured to be joined to the removable equipment and to be coupled to the first coupling, and a fastener configured to tighten the removable equipment and the second coupling to the first coupling so that the removable equipment is fastened to the aircraft structure.

### CROSS-REFERENCES TO RELATED APPLICATIONS

This application claims the benefit of the European patent application No. 22383120.7 filed on Nov. 22, 2022, the entire disclosures of which are incorporated herein by way of reference.

### FIELD OF THE INVENTION

The invention relates to a fitting device for the installation and/or removal of equipment that shall be attached to the aircraft structure. The fitting device of the invention is devoted to the installation of aircraft equipment without the need to gain access from inside the aircraft, thus avoiding space constraints within the aircraft structure.

### BACKGROUND OF THE INVENTION

Aircraft have a structure comprising frames, stringers, beams, etc., to which aircraft equipment is fitted. Some of this equipment is removably fitted.

There are several means for accomplishing removable equipment installation on aircraft structure. Fittings are used to attach in a reversible way a mechanical component such as an aircraft equipment.

Lug fittings, bolted joints and hard-point fittings are widely known.

Equipment installed with lug fittings or bolted joint requires access to the aircraft structure and enough space for performing installation tasks. These fittings might feature some capability to absorb tolerances by lugs pinned with or without a spherical ball, floating or not floating. They may also have slotted holes for absorbing certain tolerances.

Fittings located at hard-points of the aircraft are also known and allow equipment installation from the outside of the aircraft, but they permit only limited adjustment.

### SUMMARY OF THE INVENTION

The invention relates to an aircraft removable equipment fitting device. As previously stated, aircraft comprise a structure (frames, stringers, beams, . . . ) to which removable equipment is fitted or attached.

The fitting device object of the invention comprises:
a first coupling configured to be joined to the aircraft structure,
a second coupling configured to be joined to the removable equipment and to be coupled to the first coupling, and
a fastener configured to tighten the removable equipment and the second coupling to the first coupling so that the removable equipment is fastened to the aircraft structure.

According to the above, a coupling is a fitting element into which the end of another coupling can be fitted. The fastener mechanically holds together the removable equipment and the aircraft structure to attach them securely or firmly in place in a non-permanent joint. Therefore, the joint can be removed or dismantled.

The claimed invention solves the installation of the equipment from outside of the aircraft by using two couplings, one of them joined to the removable equipment and the other to the aircraft structure, and a fastener element tightening the removable equipment and the second coupling to the first coupling and hence to the aircraft structure, for instance, by passing through a portion of the removable equipment. Therefore, the fastener can be operated from the removable equipment side avoiding the need to operate the fitting from the inner structure of the aircraft.

According to the above, the first coupling is joined to the structure and the second coupling is joined, for instance, fastened by bolts or rivets, to the aircraft equipment so that the equipment together with the second coupling are placed into the inner structure of the aircraft and connected to the first coupling. Then, the fastener holds in position the aircraft equipment, the first coupling and the second coupling being actuated from the aircraft equipment side.

The claimed invention would be appropriate for aircraft equipment installed on areas with reduced accessibility from aircraft inside.

The invention combines in a single fitting the benefits of different means of attachment, avoiding their individual inconveniences.

It is also an object of the invention an aircraft removable equipment assembly comprising:
a removable equipment,
a first coupling configured to be joined to the aircraft structure,
a second coupling joined to the removable equipment and configured to be coupled to the first coupling, thus the removable equipment and the second coupling act as a whole element, and
a fastener configured to tighten the removable equipment and the second coupling to the first coupling so that the removable equipment is fastened to the aircraft structure.

It is also a further object of the invention an aircraft comprising an aircraft removable equipment assembly according to the above.

### BRIEF DESCRIPTION OF THE DRAWINGS

To complete the description and to provide for a better understanding of the invention, a set of drawings is provided. The drawings form an integral part of the description and illustrate preferred embodiments of the invention. The drawings comprise the following figures.

FIG. 1 shows a schematic cross-sectional lateral view of an embodiment of the invention.

FIG. 2 shows a schematic lateral of the embodiment of the fastener of FIG. 1.

FIG. 3 shows a schematic cross-sectional lateral view of a part of an aircraft and an embodiment of the first coupling.

FIG. 4 shows a schematic perspective view of a part of an aircraft and an embodiment of the joint of the first coupling.

FIG. 5 shows a schematic cross-sectional lateral view of an air inlet of an Auxiliary Power Unit (APU) according to an embodiment of the invention.

FIG. 6 shows a schematic plan view of the air inlet of an Auxiliary Power Unit (APU) according to the embodiment of FIG. 5.

FIG. 7 shows a schematic plan view of the air inlet of an Auxiliary Power Unit (APU) and an embodiment of a rear fitting device.

FIG. 8 shows a schematic plan view of the air inlet of an Auxiliary Power Unit (APU) and an embodiment of the rear fitting device of FIG. 7.

FIG. 9 shows a lateral view of an aircraft comprising an air inlet of an Auxiliary Power Unit (APU).

### DETAILED DESCRIPTION OF THE PREFERRED EMBODIMENTS

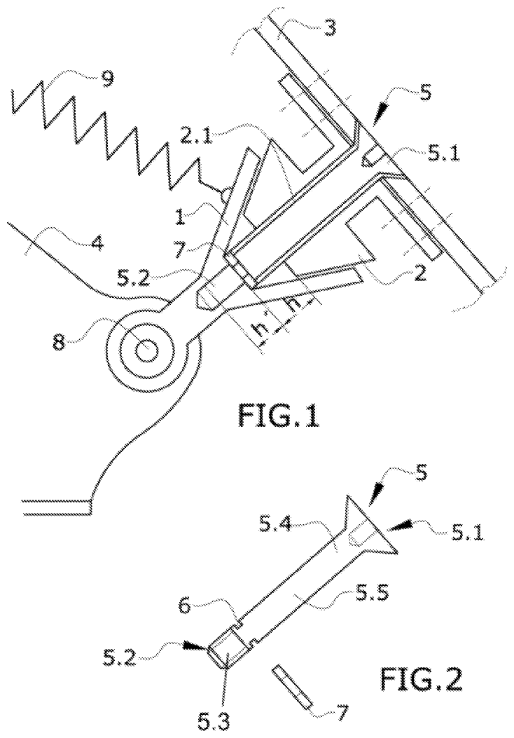

FIG. 1 shows an embodiment of the fitting device object of the invention that comprises:

A first coupling (1) joined to the aircraft structure (4).

A second coupling (2) joined to the aircraft equipment (3) and coupled to the first coupling (1). In the shown embodiment, the second coupling (2) is fastened to the aircraft equipment (3), for instance, by means of bolts or rivets.

A fastener (5) tightening the removable equipment (3) and the second coupling (2) to the first coupling (1) so that the removable equipment (3) is fastened to the aircraft structure (4).

In the shown embodiment, the first coupling (1) has a longitudinal axis, and the second coupling (2) has a longitudinal axis. More specifically, the shown fastener (5) passes through a portion of the removable equipment (3) adjacent to the second coupling (2) and is located along the longitudinal axis of the first coupling (1) and of the second coupling (2).

To pass through is to be understood as to go across or traverse the portion of the removable equipment (3) adjacent to the second coupling (2). This portion may be, for instance, a wall, a partition, or a lug of the removable equipment that is traversed or crossed by the fastener (5).

In FIG. 1, a portion of the aircraft equipment (3) has an opening for the fastener (5) so that the fastener (5) can be operated from the aircraft equipment (3) side instead of from the aircraft structure (4) side.

In the shown embodiment, the fastener (5) comprises a head (5.1) and a tip (5.2). The tip (5.2) engages on the first coupling (1) and the head (5.1) rests or lies on the removable equipment (3), specifically, on a portion of the removable equipment (3) adjacent to the first coupling (1). Thus, the fastener (5) can be operated from the head (5.1) through the previously mentioned opening of the aircraft equipment (3).

In the shown embodiment, the first coupling (1) comprises a female coupling, and the second coupling (2) comprises a male coupling.

Specifically, the first coupling (1) and the second coupling (2) are conical couplings. This particular shape helps self-aligning of the fitting device.

FIG. 2 discloses an embodiment of the fastener (5) which is specifically a bolt. The fastener (5) comprises a cylindrical elongated body comprising a first longitudinal threaded part (5.3) configured to be threaded to the first coupling (1). It also comprises a second longitudinal part (5.4) that in the fastened position is located within the longitudinal length of the second coupling (2), i.e., this second longitudinal part (5.4) is surrounded by the second coupling (2), as shown in FIG. 1. Finally, it comprises a third longitudinal part (5.5) longitudinally located between the first part (5.3) and the second part (5.4).

According to the above, the fastener (5) is operated from the head (5.2) and threaded to the first coupling (1) at its first longitudinal threaded part (5.3).

The fastener (5) further comprises a circumferential slot (6), i.e., a slot surrounding its cylindrical body, located at its third part (5.5) adjacent to the first longitudinal threaded part (5.3). It also comprises a circumferential retainer element (7) located at the circumferential slot (6). The circumferential retainer element (7) has an outer radius dimension such that the dimension of the circumferential retainer element (7) retains the fastener (5) within the second coupling (2).

In the shown embodiment, the second coupling (2) comprises an internal through hole (2.1) and the circumferential retainer element (7) has an outer radius, the radius at a greater distance from the center, larger than the radius of the internal through hole (2.1) of the second coupling (2). Therefore, the dimensions of the circumferential retainer element (7) retain the fastener (5) within the second coupling (2).

As can be seen in FIG. 1, the longitudinal length of the longitudinal threaded first part (5.3) is smaller than the longitudinal length of the third part (5.5). It allows the removal of the fitting device while the fastener (5) is retained in the second coupling (2).

According to the above, fasteners (5) are captive in the second coupling (2), i.e., on the male coupling, to ensure they cannot fall off from the second coupling (2). It avoids any fastener (5) being loosen and, for instance, being ingested by an air duct.

Alternatively, fasteners (5) may be screwed to coils, specifically replaceable and self-locking female threads, inserted on the first coupling (1) to ensure fasteners (5) will not get untighten.

FIG. 4 shows a schematic perspective view of an embodiment of the joint of the first coupling (1) to the aircraft structure (4). The embodiment's configuration provides a simply support in which translational degrees of freedom are restricted, while rotational ones are not restricted. According to the shown embodiment, the first coupling (1) is joined to the aircraft structure (4) by a pin and lug fitting (10) featuring a spherical bearing, as can be seen, for instance, in FIGS. 1, 3 and 4.

In an embodiment, the fitting between the first coupling (1) and the aircraft structure (4) comprises a spherical bearing (8). Thus, tolerance of relative position between the first coupling (1) and the second coupling (2) are absorbed at the aircraft structure (4) side, i.e., at the first coupling (1), on angles, by the spherical bearings (8) on the joint of the first coupling (1) to the aircraft structure (4).

The above configuration ensures that no moment loading will be transferred, neither bending or torsional, from the first coupling (1) to the fitting fastened to the aircraft structure (4).

Moreover, the above embodiment can either transfer load in the pin direction in a fixed configuration wherein the lug of the first coupling (1) is fixed along the clevis pin direction, or not transfer load in a floating configuration. The pin and lug fitting (10) avoids translations in X and Z-direction and rotations around X and Z.

Particularly, combining two fitting embodiments in a single side of the removable equipment (3), one with its first coupling (1) lug fixed in the pin direction and the other with its first coupling (1) lug floating in the pin direction, does not over-constrain or pre-stress the removable equipment (3) in any direction. In that case, one of the fittings is a bearing so that translations in Y-direction are also avoided. Therefore, only the rotation around the Y-direction is left that allows inserting the removable equipment (3) in its place. Afterwards, rotation in the Y-direction is constrained.

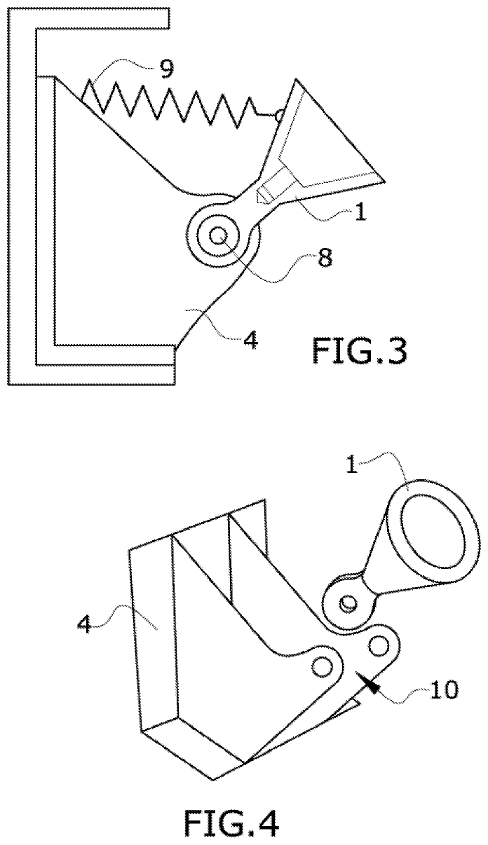

FIG. 3 discloses that the fitting device also comprises an elastic element (9) joined to the first coupling (1) and to the aircraft structure (4) for holding the first coupling (1).

Thus, to hold the first coupling (1) in an approximate nominal installation position, elastic elements (9), specifically springs, are positioned between the first coupling (1) and the aircraft structure (4). More specifically, an intermediate plate is added which is lastly fastened to the aircraft structure (4).

These springs do not fulfil a structural task, i.e., they do not take any load once equipment installation is completed. More specifically, the turning degree of freedom of the equipment around their coupling axes, is blocked by additional restrains on other parts of the aircraft equipment.

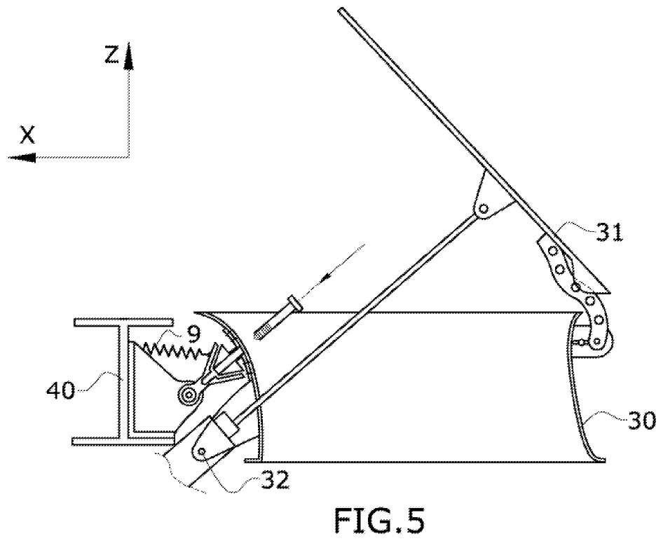

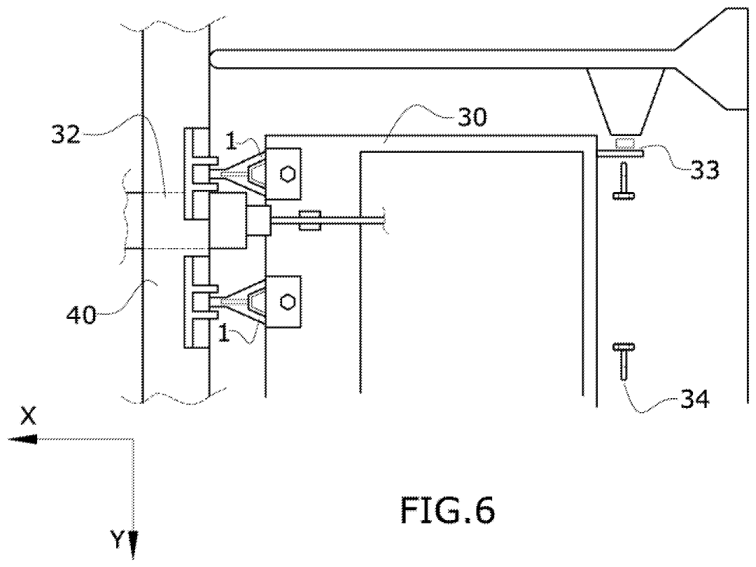

The embodiment shown in FIGS. 5 and 6 show an air inlet of an Auxiliary Power Unit (APU). More specifically, it shows a funnel (30) of the air inlet which is the aircraft equipment (3) to be attached to the aircraft structure (4).

The embodiment shows two first couplings (1), two second couplings (2) and two fasteners (5). Therefore, two fitting points are depicted. The two second couplings (2) are joined to the removable equipment (3), i.e., the funnel (30), and the first couplings (1) are joined to the aircraft structure (4).

In the shown embodiment, one of the lugs of the spherical bearing (8) of the pin and lug fitting (10) is floating in the pin direction. Thus, tolerance of relative position between the first coupling (1) and the second coupling (2) are absorbed at the aircraft structure (4) side fittings, i.e., at the first coupling (1) on an Y-direction because one of the lug fittings is floating in the pin direction.

FIGS. 5 and 6 disclose an aircraft removable equipment (3) assembly comprising:
the removable equipment (3), which is the air inlet comprising the funnel (30) which in turn comprises a door (31),
two first couplings (1) joined to the aircraft structure (4),
two second couplings (2) joined, for instance, rivetted or bolted, to the removable equipment (3) and coupled to the first coupling (1), and
two fasteners (5) configured to tighten the removable equipment (3) and the second couplings (2) to the first couplings (1) so that the removable equipment (3) is fastened to the aircraft structure (4).

Specifically, the fasteners (5) pass through two openings in a portion of the funnel (30) wall and their heads (5.1) are allocated into the openings.

More particularly, FIGS. 5 and 6 show a portion of a frame (40) of an Auxiliary Power Unit (APU) section and the air inlet configuration that has to be joined to the mentioned frame (40). The funnel (30) of the air inlet can be installed and removed from the outside the aircraft.

Thus, the invention allows having an air intake part that can be removed as a whole from the outside part of the aircraft, i.e., without accessing the inside of the aircraft by opening an air intake door (31) so that it can be detached from the inside of the funnel (30). In the shown embodiment, the door (31) is pivotally hinged to the funnel (30).

In addition, the funnel (30) comprises additional rear fittings (33, 34), specifically two fittings (33, 34), located on an opposite side of the funnel (30) to the first and second couplings (1, 2).

In the shown embodiment, one of the two rear fittings (33) only transmits load in Z direction. It allows to prevent rotation around Y-direction for the front fittings, i.e., couplings (1, 2).

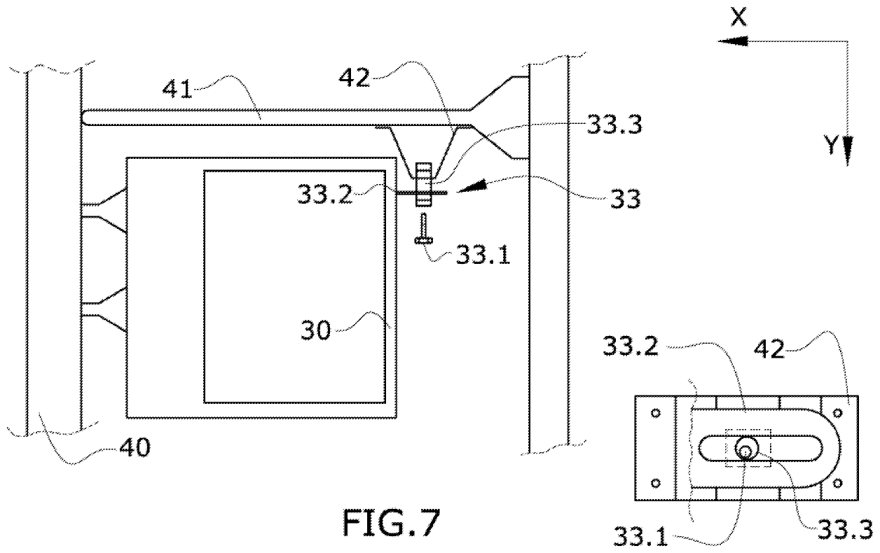

FIG. 7 discloses an embodiment of the rear fitting (33). The rear fitting (33) attaches the funnel (30) to a beam (41), specifically through an omega profile (42).

In the embodiment, the rear fitting (33) comprises a bolt (33.1), a lug (33.2) joined to the funnel (30) and a bushing (33.3) holding the bolt (33.1). In an embodiment, the lug (33.2) is an elongated lug (33.2) extending in the X-direction with an elongated opening through it so that the bolt (33.1) and bushing fit through the opening in the Y-direction. The bolt (33.1) and bushing are free to translate in the opening of the lug along the Y-direction. Therefore, as previously stated, the rear fitting (33) transmits loads in the Z-direction only.

Moreover, the bushing (33.3) comprises an eccentric hole for the mounting of the bolt (33.1) through it, so as to adjust the height of the bolt (33.1) and bushing (33.3) assembly along the Z-direction in the opening of the elongated lug (33.2).

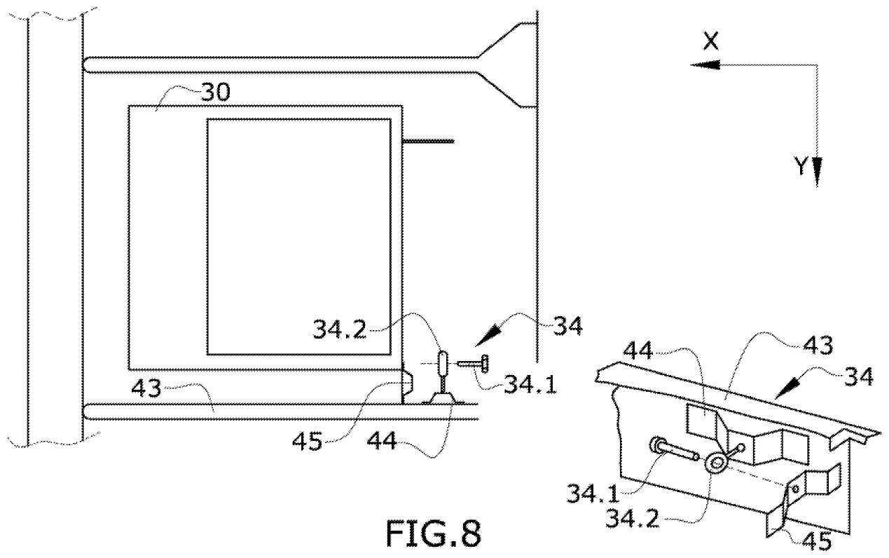

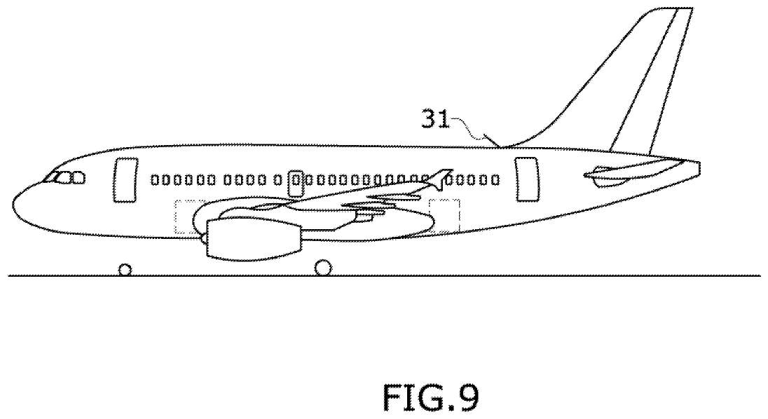

The other rear fitting (34), which is depicted in FIG. 8, transmits loads in Y and Z-directions. The rear fitting (34) attaches the funnel (30) to a beam (43), in the shown embodiment specifically through a first omega profile (44). In the embodiment of FIG. 8, the rear fitting (34) comprises a bolt (34.1), a lug (34.2) joined to the mentioned first omega profile (44) and an additional omega-profile (45) receiving the bolt (34.1) and joined to the funnel (30). Specifically, in the shown embodiment, the lug (34.2) is located and adjustable in the Y-direction. The lug (34.2) comprise an opening adapted to receive the bolt (34.1) through it in the X-direction. The bolt (34.1) is adapted to translate freely along the X-direction through the opening of the lug (34.2), while it is restrained along the Y and Z-directions. Therefore, as previously stated, the rear fitting (34) transmits loads in the Y and Z-directions.

The aircraft structure (4) comprises a panel, not disclosed, in the proximity of the rear fittings (33, 34) for gaining access to them.

In addition, the funnel (30) comprises an actuator (32) for its aperture. The actuator (32) is attached to the funnel (30) and to the door (31), so that the actuator (32) is removed with the funnel (30) when the funnel (30) is removed. The actuator (32) is not attached to the aircraft structure (4) and when removing the funnel (30) only the fittings, couplings (1, 2) and rear fittings (33, 34) have to be removed.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft removable equipment fitting device for use in an aircraft, the aircraft comprising a structure to which removable equipment is configured to be attached, the aircraft removable equipment fitting device comprising:
a first coupling configured to be joined to the aircraft structure,
a second coupling configured to be joined to the removable equipment and to be coupled to the first coupling, and
a fastener configured to tighten the removable equipment and the second coupling to the first coupling so that the removable equipment is fastened to the aircraft structure.

2. The aircraft removable equipment fitting device, according to claim 1, wherein the first coupling and the second coupling has a longitudinal axis, and the fastener passes through a portion of the removable equipment adjacent to the second coupling and is located along the longitudinal axis of the first coupling and of the second coupling.

3. The aircraft removable equipment fitting device, according to claim 2, wherein the fastener comprises a head and a tip and, in a fastened position, the tip is configured to engage with the first coupling and the head is configured to rest on the removable equipment.

4. The aircraft removable equipment fitting device, according to claim 1, wherein the fastener comprises a cylindrical elongated body comprising a first longitudinal threaded part configured to be threaded to the first coupling, a second longitudinal part, that in a fastened position, is located within a longitudinal length of the second coupling and a third longitudinal part longitudinally located between the first part and the second part.

5. The aircraft removable equipment fitting device, according to claim 4, wherein the fastener comprises a circumferential slot located at its third part adjacent to the first part and a circumferential retainer element configured to be located at the circumferential slot and having an outer radius dimension such that the dimensions of the circumferential retainer element retain the fastener within the second coupling.

6. The aircraft removable equipment fitting device, according to claim 5, wherein the longitudinal length of the threaded first part is smaller than the longitudinal length of the third part.

7. The aircraft removable equipment fitting device, according to claim 1, wherein the first coupling is configured to be joined to the aircraft structure by a fitting configured to restrict translational degrees of freedom and allow rotational degrees of freedom.

8. The aircraft removable equipment fitting device, according to claim 7, wherein the fitting between the first coupling and the aircraft structure is a pin and lug fitting comprising a spherical bearing.

9. The aircraft removable equipment fitting device, according to claim 1, wherein the fitting device comprises an elastic element configured to be joined to the first coupling and to the aircraft structure.

10. The aircraft removable equipment fitting device, according to claim 1, wherein the fitting device comprises two first couplings, two second couplings and two fasteners, the two first couplings configured to be joined to the aircraft structure and the two second couplings configured to be joined to the removable equipment.

11. The aircraft removable equipment fitting device, according to claim 8,
wherein the fitting device comprises two first couplings, two second couplings and two fasteners, the two first couplings configured to be joined to the aircraft structure and the two second couplings configured to be joined to the removable equipment, and
wherein one of two lugs of the pin and lug fitting is floating.

12. An aircraft removable equipment assembly for an aircraft, the aircraft comprising a structure to which removable equipment is configured to be attached, the aircraft removable equipment assembly comprising:
a removable equipment,
a first coupling configured to be joined to the aircraft structure,
a second coupling joined to the removable equipment and configured to be coupled to the first coupling, and
a fastener configured to tighten the removable equipment and the second coupling to the first coupling so that the removable equipment is fastened to the aircraft structure.

13. The aircraft removable equipment assembly, according to claim 12, wherein the removable equipment is a funnel of an Auxiliary Power Unit compartment.

14. The aircraft removable equipment assembly, according to claim 13, wherein the funnel comprises an inlet door and an actuator joined to the funnel and to the inlet door.

15. An aircraft, comprising a structure and an aircraft removable equipment assembly according to claim 12 attached to the structure.
